(19) United States
(12) Patent Application Publication
(10) Pub. No.: US 2009/0083049 A1
(43) Pub. Date: Mar. 26, 2009

(54) CLAIM CHART CREATION SYSTEM

(76) Inventors: David M. Sciarrino, Belmont, CA (US); Edward J. Peeler, San Francisco, CA (US)

Correspondence Address: HENNEMAN & ASSOCIATES, PLC, 714 W. MICHIGAN AVE., THREE RIVERS, MI, 49093, US

(21) Appl. No.: 11/860,509

(22) Filed: Sep. 24, 2007

(51) Int. Cl. G06Q 99/00

(52) U.S. Cl. 705/1

(57) ABSTRACT

A process for creating a claim chart. Information is maintained in a database about a patent portfolio including at least one patent including at least one claim having at least one claim element and about a product portfolio including at least one product having at least one product characteristic. A collection of proof pieces are maintained in the database each representing an assertion about a product characteristic. A current product in the product portfolio, a current patent in the patent portfolio, and a current claim in the current patent are selected. For each claim element of the current claim, an element proof is constructed by selecting a proof piece showing that a product characteristic of the current product matches the claim element. Then a document is generated showing the claim chart as a collection of the element proofs.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to computerized document generation, and more particularly to such for patent claim charts.

2. Background Art

Developing claim charts that prove patent infringement is a process that utilizes information garnered from various and diverse sources. As is well known, an issued patent will include one or more claims. While the patent specification describes the invention, the claim or claims are what are used to enforce the patent against infringing use of the invention. Each claim is, typically, made up of several claim elements, and the goal is to produce a claim chart of “element proofs” in which each element is matched with one or more “proof pieces” showing how an infringing product includes the claim element. [The labels “element proof” and “proof piece” are used here because they are highly descriptive, and because there are no widely used terms for these in the industry.]

In the course of preparing a claim chart, the claim elements usually are chosen to encompass a single idea or concept within the invention (the invention being the sum of all the ideas and concepts listed as claim elements), and then proof pieces are added to show that the claim element is present in the product.

An example of how claims are split into claim elements is shown below for claim 1 of U.S. Pat. No. 5,809,336:
A microprocessor system, comprising a single integrated circuit including a central processing unit and an entire ring oscillator variable speed system clock in said single integrated circuit and connected to said central processing unit for clocking said central processing unit, said central processing unit and said ring oscillator variable speed system clock each including a plurality of electronic devices correspondingly constructed of the same process technology with corresponding manufacturing variations, a processing frequency capability of said central processing unit and a speed of said ring oscillator variable speed system clock varying together due to said manufacturing variations and due to at least operating voltage and temperature of said single integrated circuit; an on-chip input/output interface connected to exchange coupling control signals, addresses and data with said central processing unit; and a second clock independent of said ring oscillator variable speed system clock connected to said input/output interface.

This is obviously awkward to work with, so it is split into the seven claim elements listed below:
1) A microprocessor system,
2) comprising a single integrated circuit including a central processing unit
3) and an entire ring oscillator variable speed system clock in said single integrated circuit and connected to said central processing unit for clocking said central processing unit,
4) said central processing unit and said ring oscillator variable speed system clock each including a plurality of electronic devices correspondingly constructed of the same process technology with corresponding manufacturing variations,
5) a processing frequency capability of said central processing unit and a speed of said ring oscillator variable speed system clock varying together due to said manufacturing variations and due to at least operating voltage and temperature of said single integrated circuit;
6) an on-chip input/output interface connected to exchange coupling control signals, addresses and data with said central processing unit; and
7) and a second clock independent of said ring oscillator variable speed system clock connected to said input/output interface.

There is no particular magic to the breaking out of claim elements from a claim itself. In this regard, the choices are somewhat arbitrary and require a strong command of the technology and an expert understanding of the concepts of the patent itself. Yet breaking the claim language into digestible pieces allows engineers, scientists, attorneys, and business people to easily grasp the concepts laid out within the claim chart.

Once the claim above has been broken into the claim elements listed above, the proof pieces are added and the element proofs are thus constructed. Historically, the proof pieces have usually been text statements, but this is not a limitation, and diagrams, pictures, etc. are also suitable to present argument that the claim elements are present in an infringing product.

FIGS. 1a-b (background art) show portions of a claim chart 50 illustrating how the claim elements above might appear. In FIG. 1a, one claim element 52 and one proof piece 54 are shown. The claim element 52 is simply a statement of the literal language recited in the claim for this element. The proof piece 54 here includes a picture 56 and a note 58. The picture 56 is of a microprocessor system in the product being reviewed for infringement. [Specifically, the picture here was copied from a schematic diagram found in a manufacturer's repair manual for this product.] In FIG. 1b two claim elements 52 and two proof pieces 54 are shown. Again, the claim elements 52 are simply statements of the literal language recited in the claim for these elements. In contrast, the first proof piece 54 here includes a quotation of text from a treatise and the second proof piece 54 here includes a quotation of text and a graph from another treatise. Both proof pieces 54 in FIG. 1b further have accompanying notes 58. Thus, using a standard claim chart construction format with the claim element 52 on the left and the proof piece 54 on the right, the element is proven.

Most intellectual property (IP) licensing firms today use customized and overwhelmingly manual approaches to developing claim charts, and product reports based on them. Historically, IP licensing firms have found this adequate and have not thought to attempt to extend its scale or scope.

Proceeding thus, the present inventors and their employer in 2004 tried to apply traditional approaches when marketing a major patent portfolio, where it was necessary to generate a large quantity of claim charts directed at many different industries. The results were found to be seriously wanting. Their marketing efforts were highly successful, but were limited by the quantity and (to a limited extent) by the quality of the claim charts that could be produced.

Accordingly, the present inventors next tried to extend the traditional approaches using what appeared to be the most straightforward methods and tools. Word processor document templates were created and the tasks required to use them were semi-automated. These were then employed throughout 2005, but this approach was also found wanting. It became evident that a more powerful claim chart creation system was needed if the present inventors and their employer were going to expand their licensing operation to the scope that there patent portfolios permitted and merited, and to the scale that they envisioned.

### BRIEF SUMMARY OF THE INVENTION

Accordingly, it is an object of the present invention to provide an improved claim chart creation system.

Briefly, one preferred embodiment of the present invention is a process for creating a claim chart. Information about a patent portfolio is maintained in a database, wherein the patent portfolio includes at least one patent which includes at least one claim which has at least one claim element. Information about a product portfolio is also maintained in the database, wherein the product portfolio includes at least one product which has at least one product characteristic. A collection of proof pieces are further maintained in the database that each represent an assertion about a product characteristic. A current product is selected that is in the product portfolio. A current patent is selected that is in the patent portfolio. A current claim is selected that is in the current patent. For each claim element in the current claim, an element proof is constructed by selecting a proof piece showing that a product characteristic of the current product matches the claim element. Then a document is generated showing the claim chart as a collection of the element proofs.

Briefly, another preferred embodiment of the present invention is a computer program, embodied on a computer readable storage medium, for creating a claim chart. A code segment maintains information about a patent portfolio in a database, wherein the patent portfolio includes at least one patent which includes at least one claim which has at least one claim element. A code segment maintains information about a product portfolio in the database, wherein the product portfolio includes at least one product which has at least one product characteristic. A code segment maintains a collection of proof pieces in the database that each represent an assertion about a product characteristic. A code segment permits selection of a current product that is a product in the product portfolio. A code segment permits selection of a current patent that is a patent in the patent portfolio. A code segment permits selection of a current claim that is a claim in the current patent. A code segment constructs an element proof for each claim element of the current claim by selection of a proof piece showing that a product characteristic of the current product matches the claim element. And a code segment generates a document showing the claim chart as a collection of the element proofs.

And briefly, another preferred embodiment of the present invention is a system for creating a claim chart. A means is provided for maintaining information about a patent portfolio in a database, wherein the patent portfolio includes at least one patent which includes at least one claim which has at least one claim element. A means is provided for maintaining information about a product portfolio in the database, wherein the product portfolio includes at least one product which has at least one product characteristic. A means is provided for maintaining a collection of proof pieces in the database that each represent an assertion about a product characteristic. A means is provided for selecting a current product that is a product in the product portfolio. A means is provided for selecting a current patent that is a patent in the patent portfolio. A means is provided for selecting a current claim that is a claim in the current patent. A means is provided for constructing an element proof for each claim element of the current claim by selecting a proof piece showing that a product characteristic of the current product matches the claim element. And a means is provided for generating a document showing the claim chart as a collection of the element proofs.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIGS. 1a-b (background art) shows show portions of a claim chart 50 illustrating how the claim elements above might appear.

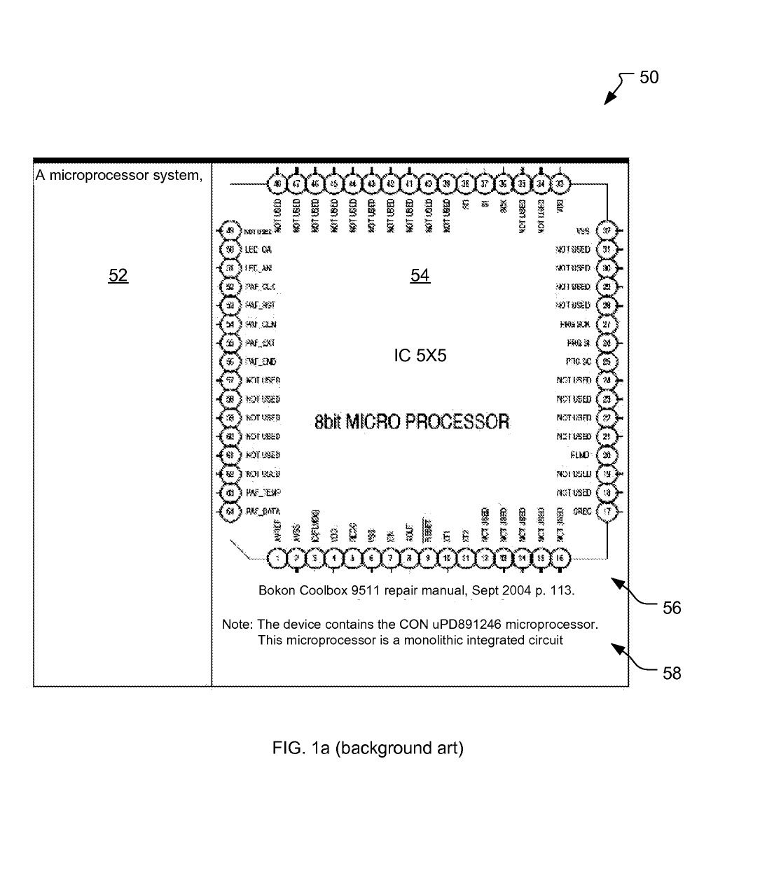

FIG. 2 is a block diagram stylistically showing an analysis system in accord with the present invention.

FIG. 3 is a view of a portion of a general screen that an analyst can encounter when working with the analysis system.

FIG. 4 is a view of a portion of a work in progress (WIP) claim chart screen that the analyst will encounter (after operating a button in FIG. 3 to access a claim charts module).

FIG. 5 is a view of a portion of a second WIP claim chart screen that the analyst will encounter (after operating a navigation control in FIG. 4 that is labeled “Next”).

FIG. 6 is a view of a portion of a third WIP claim chart screen that the analyst will encounter (after operating a navigation control in FIG. 5 that is labeled “Continue”).

FIG. 7 is a view of a portion of a fourth WIP claim chart screen that the analyst will encounter (after operating a navigation control in FIG. 6 that is labeled “Finish”).

FIG. 8 is a view of a portion of a fifth WIP claim chart screen that the analyst will encounter (after operating a claim element link in FIG. 7 to drill down).

FIG. 9 is a view of a portion of a first review claim chart screen that the analyst will encounter (after selecting a review tab while using the claim charts module).

FIG. 10 is a view of a portion of a first patents screen that the analyst will encounter (after operating a button in FIG. 3 to access a patents module).

FIG. 11 is a view of a portion of a second patents screen that the analyst will encounter (after operating an element link in FIG. 10 to drill down).

FIG. 12 is a view of a portion of a third patents screen that the analyst will encounter after operating a new claim button in FIG. 11).

FIG. 13 is a view of a portion of a product report screen that the analyst will encounter after operating (after operating a button in FIG. 3 to access a product reports module).

In the various figures of the drawings, like references are used to denote like or similar elements or steps.

### DETAILED DESCRIPTION OF THE INVENTION

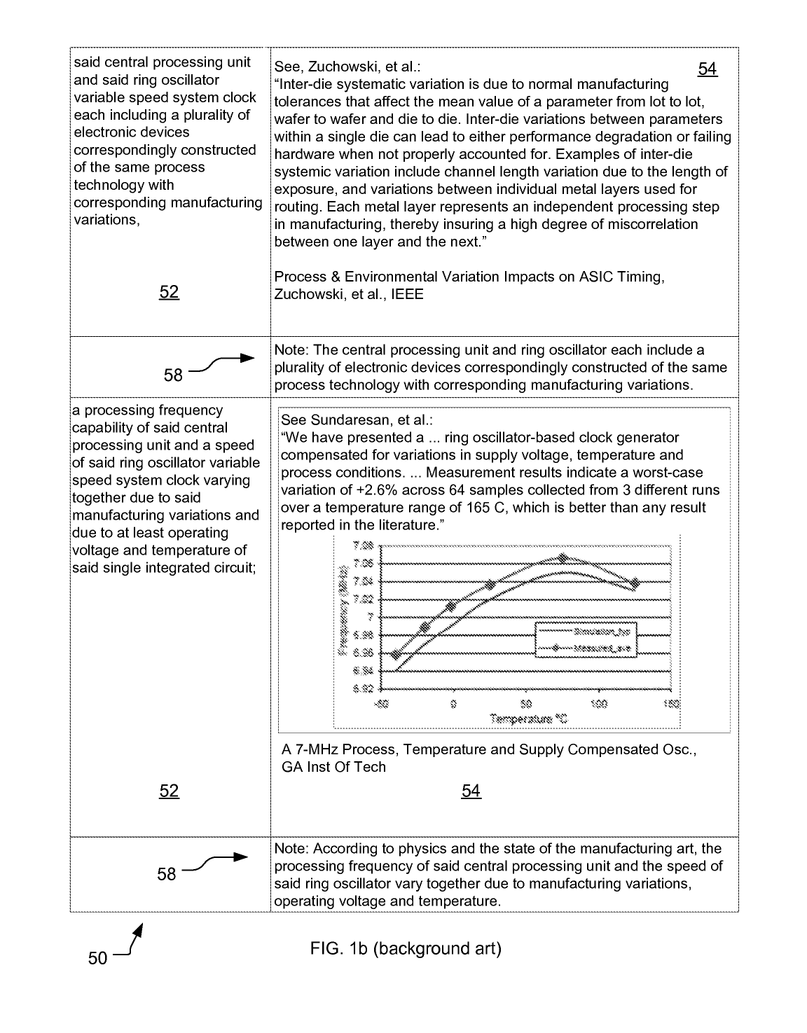

A preferred embodiment of the present invention is an improved claim chart creation system, that optionally can incorporate claim charts into product reports. As illustrated in the various drawings herein, and particularly in the view of FIG. 2, preferred embodiments of the invention are depicted by the general reference character 100.

FIG. 2 is a block diagram stylistically showing an analysis system 100 in accord with the present invention. That is, showing a tool and the environment it is used in for performing many of what have traditionally been manual tasks associated with preparing claim charts and product reports. The present inventors' approach automates many of these tasks, greatly increasing the volume of individual claim charts that are generated, and especially increasing the quality of the product reports that they are incorporated into. In patent licensing scenarios, this accordingly increases the likelihood that a licensing agreement can be reached rather than litigation being resorted to.

The analysis system 100 is typically important to two major parties. The first of these is a licensor 112, which usually, but not necessarily, owns or otherwise has legal rights in a patent portfolio 114. Usually the licensor 112 has one or more analysts 116 that directly use the analysis system 100. [Although “licensor” might be a misnomer in rare situations, the term is used herein due to its descriptive benefits assisting in conveying general principles that are relevant to the present invention.]

The second major party that is important in the context of the analysis system 100 is a prospective licensee 118, which typically, but also not necessarily, manufactures or otherwise has legal responsibilities for a product portfolio 120. [In some rare situations “licensee” may also be a misnomer, but the term is also used herein for reasons similar to why “licensor” is used.]

A “project” represents the lifecycle of a combination of a patent portfolio 114 of the licensor 112 and a product portfolio 120 of a prospective licensee 118. It should be noted that there is a time-dynamic aspect to projects, and that the lifecycle of a patent portfolio 114 tends to govern this because it is usually a known, fixed period which extends from the filing date of the earliest filed patent application in the patent portfolio 114. The product portfolios 120 and the prospective licensees 118 can also be spoken of as having lifecycles, but these usually only have importance in very specialized situations that an analyst 116 can handle based on a particularized knowledge of the applicable patent law. Accordingly, as will be seen below, the respective functionalities of the modules in the analysis system 100 are generally designed to relate to projects.

The licensor 112 uses the analysis system 100 to create a product report 122 based on the patent portfolio 114, which the licensor 112 may then elect to provide a copy of to the prospective licensee 118, to demonstrate that something in the product portfolio 120 infringes the patent portfolio 114. The product report 122 particularly includes one or more claim charts 124. The claim charts 124 can, however, have such importance and general utility, even aside from a product report 122, that they can be regarded as another major output of the analysis system 100.

The analysis system 100 has numerous inputs and, rather than attempt to exhaustively list them all here, it is more productive to treat them as shown. That is, to group them as patent portfolio information 126, product portfolio information 128, prospective licensee information 130, and other information 132. The data from these inputs is stored in one or more database tables 134 in the analysis system 100.

Since claim charts 124 are a major building block of the product reports 122, and they are also often important in their own right, an analyst 116 may spend appreciable time working with them and the claim chart module provides a good place to start a more detailed consideration of the analysis system 100. It is useful to consider the process of preparing a claim chart 124 from the perspective of the analyst 116 preparing it. The analyst 116 is assigned a project. For example here, the “Bokon—MMP Portfolio” project wherein the licensor 112 is Technology Properties Limited (“the TPL Group”; N.b. Alliacense is a TPL Group Enterprise), the patent portfolio 114 is the “Moore Microprocessor Portfolio” (a set of patents on microprocessor inventions by Charles H. Moore and others), the prospective licensee 118 is Bokon Corporation (a hypothetical company name used here merely for the sake of example and intended to convey no direct or implied relationship to any actual company), and the product portfolio 120 is that company's line of digital cameras. Typically, the project and data about the prospective licensee 118 will have previously been added to the analysis system 100 by a manager or other research analyst. Although this can also be done “on the fly.”

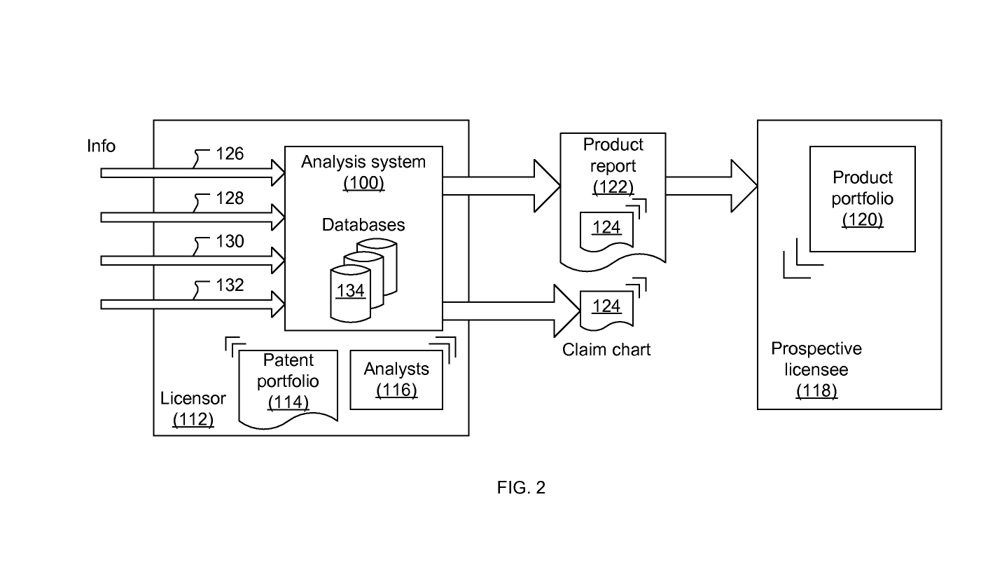

FIG. 3 is a view of a portion of a general screen 200 that an analyst 116 can encounter when working with the analysis system 100. Various general navigation controls 202 are provided in the screen 200 (and in other screens discussed presently). These navigation controls 202 are similar to ones found in many software products today and skilled software artisans will, of course, appreciate that these can be conventional in their nature as controls (albeit, quite unconventional in the functionality that they controllably access). Of present interest are the buttons (buttons 204 collectively and buttons 204a-u individually) shown on the left-side of FIG. 3. These are arranged in alphabetical order to facilitate an analyst 116 finding them. To discuss them, however, it is instead useful to consider the relative importance of the functionality that they access, as well as their relationship to already covered concepts. The functionality that the respective buttons 204 access is generally embodied in similarly named software modules within the analysis system 100.

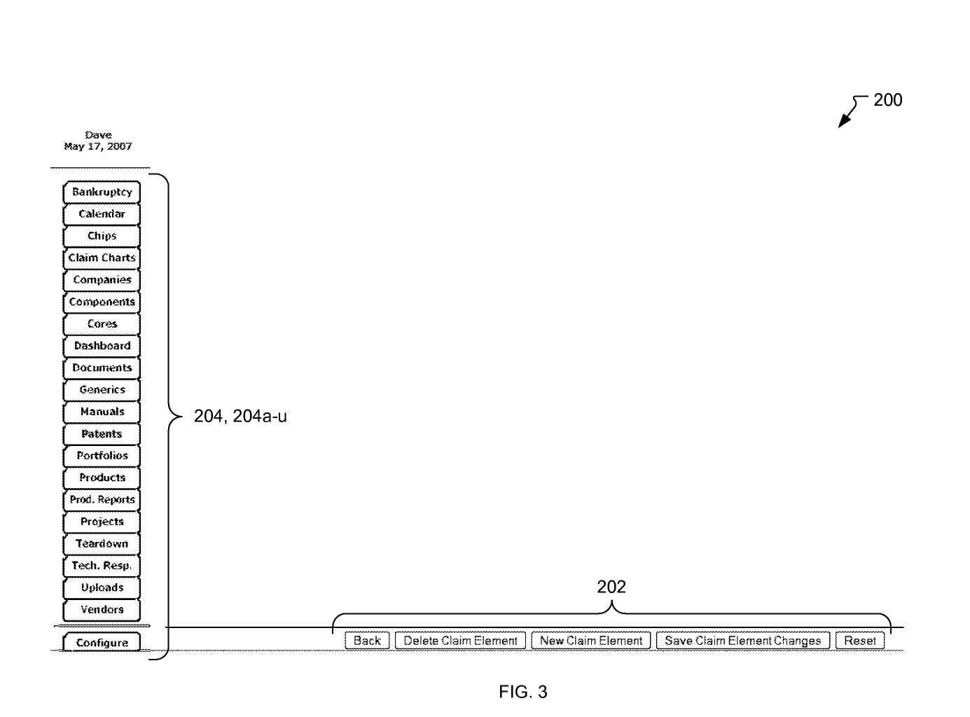

FIG. 4 is a view of a portion of a work in progress (WIP) claim chart screen 300 that the analyst 116 will encounter after operating the button 204d to access its corresponding claim charts module. The screen 300 includes only a new claim chart section 302. As can also be seen here, the analysis system 100 also uses tabs in some modules to control workflow and information presentation. Here the tabs (tabs 304 collectively and tabs 304a-f individually) are labeled: WIP (work-in-progress), Review, Rework, Finalized, Dead, and Search.

The screen 300 under the WIP tab 304a is shown. Included in it are a project drop-down list 306, a radio-button control 308, and more navigation controls 202. In keeping with the project-centric design of this embodiment of the analysis system 100, the project drop-down list 306 permits an analyst 116 to select which project they will work on. [N.b., In the inventor's presently preferred embodiment of the analysis system 100 only an analyst 116 with supervisory authority creates new projects, which are then stored and later accessed as described here.] The radio-button control 308 then permits the analyst 116 to select whether a claim chart 124 will relate to a component (“Component”) of a product, to an entire product (“Product”), or to use of a product (“Retail”). Note, “Retail” here conceptually encompasses an entire chain of commerce where the nature of infringement is the use of a product in some manner once it has been manufactured. Accordingly, “use” here is meant broadly and includes, for example, sale of a product.

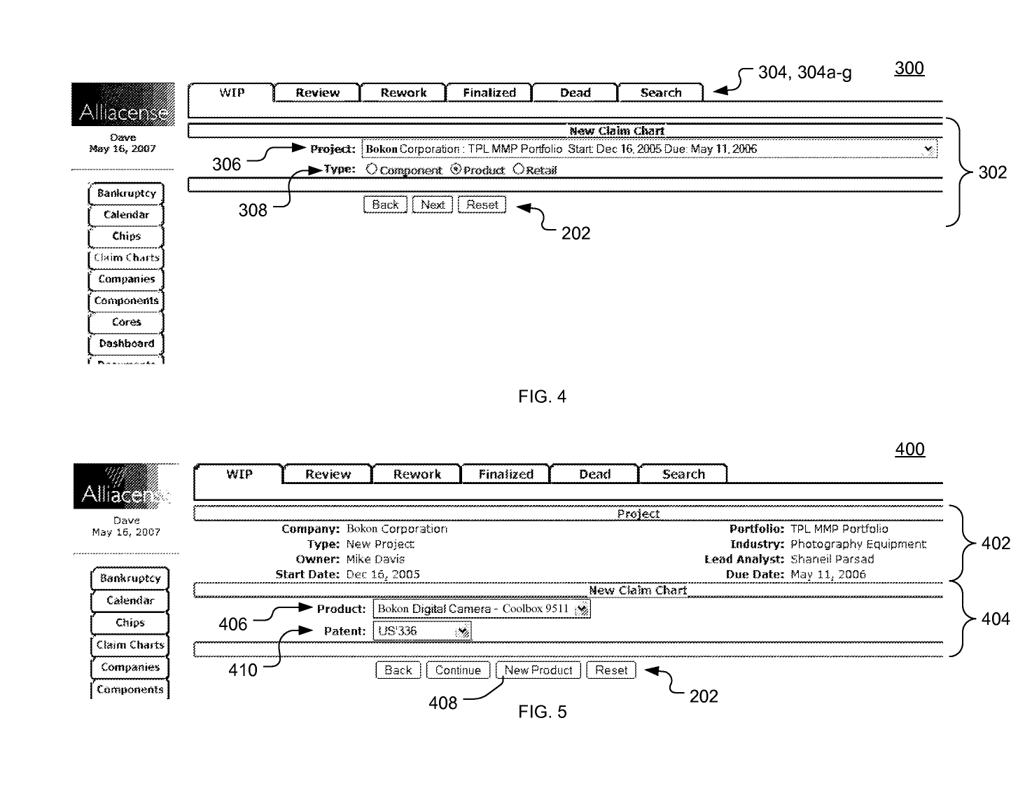

FIG. 5 is a view of a portion of a second WIP claim chart screen 400 that the analyst 116 will encounter (after operating the navigation control 202 in FIG. 4 that is labeled “Next”). Included here are a project section 402 and a new claim chart section 404.

Again in keeping with the project-centric design of this embodiment, the project section 402 presents general project summary information.

The new claim chart section 404 here provides access to additional controls. Since the “Product” option in the radio-button control 308 was selected in FIG. 4, a product drop-down list 406 is provided here to permit selecting a product. Alternately, a new product button 408 can be used to go to functionality where details for a new product can be added, and then screen 400 can be returned to and the product drop-down list 406 used to select the added product. Further provided in screen 400 is a patent drop-down list 410, which is used to select a particular patent that includes the claim that the present claim chart 124 will be associated with. Note, since adding patents is relatively rare compared to adding products, all adding of patents in this embodiment is done in the patents module (accessed with the button 2041 and discussed presently).

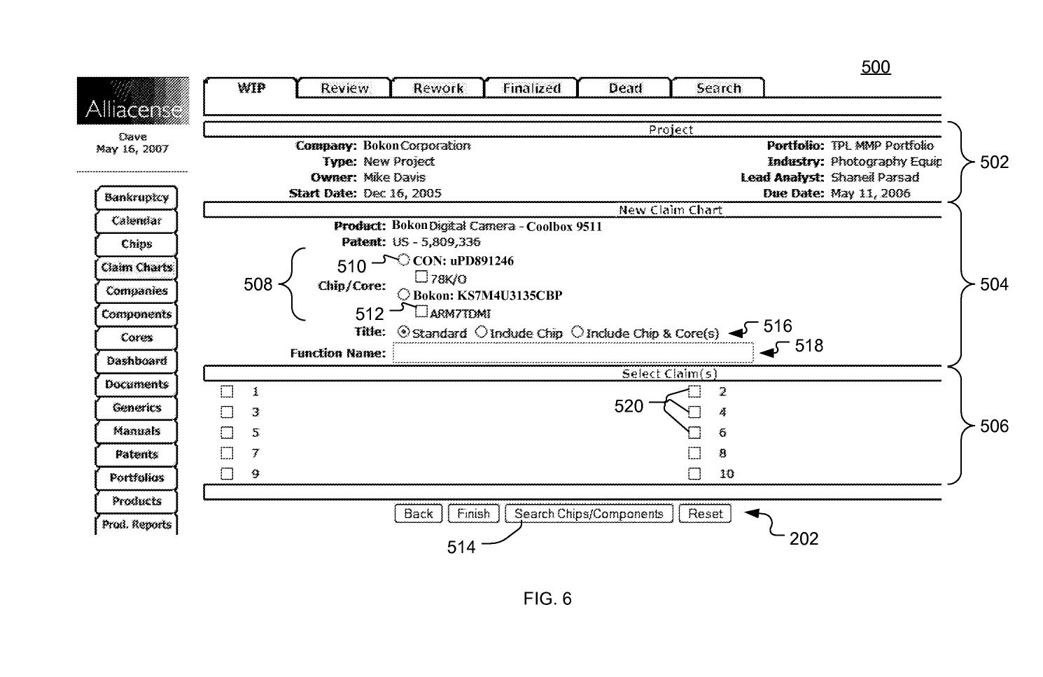

FIG. 6 is a view of a portion of a third WIP claim chart screen 500 that the analyst 116 will encounter (after operating the navigation control 202 in FIG. 5 that is labeled “Continue”). Included here are a project section 502, a new claim chart section 504, and a select claims section 506.

The project section 502 here presents the general project summary information again.

In contrast, the new claim chart section 504 here presents information about the previously specified product and patent, and further provides access to additional controls. If any chips or cores are already associated in the analysis system 100 with the currently selected product, a set of component selection controls 508 are provided. Such associations can exist, for example, if a claim chart 124 for the same product and a different patent has already been prepared. This allows the analyst 116 to re-use information (including claim element proofs) for any of the many possible patents in a patent portfolio 114. In the example shown here, two such components exist and two corresponding chip radio-buttons 510 with respective core check boxes 512 are provided. Skilled software artisans will, of course, appreciate that many different control-types can be used, and that the particular arrangement of radio-buttons and check boxes used here are mere matters of design choice. Continuing, in the new claim chart section 504 the analyst 116 can choose to select one (or both) of the two chip radio-buttons 510, to indicate that they are requesting a claim chart 124 which summarizes (if any claim elements from a previously completed claim chart 124 apply to the new claim chart 124 to be created) for the currently selected patent. Alternately, the analyst 116 can use a search chips/components button 514 to go to functionality where they can search for other components that are known within the analysis system 100, and to now associate one or more of them with the currently selected product. (Any relevant claim element proofs stored in the analysis system 100 for this selected component will be available to be used in the new claim chart 124, should they be applicable.) Additionally, the analyst 116 can use the button 204f to access the components module and add information to make new components known to the analysis system 100, which then can be selected and associated with the currently selected product in the manner just described. [N.b., as a matter of policy a licensor 112 may have an analyst 116 with supervisory authority or a single designated analyst 116 enter new components, in the interest of description consistency.]

In screen 500, whether none, one (as shown for each chip here in FIG. 6), or more core check boxes 512 are presented is dictated by how many cores are known to be in a given chip. Of course, additional cores within a chip/component can always be added, as they or their particular features become known to the analysts 116. Note also, the use of the check box control-type here permits non-selection of a core, say, because it is the entire component that is being analyzed for infringement rather than merely a single core within it.

Below the component selection controls 508 are a title radio-button 516 and a function name text box 518. The title radio-button 516 permits the analyst 116, in straightforward manner, to use a title format that is standard within the analysis system 100, or to use a title format that includes chip and/or core specific information as well. The function name text box 518 permits the analyst 116 to, optionally, enter a function-descriptive name for the chip and/or core. For instance, the text “USB Controller” might be entered here if that is the function of the particular chip/core in the currently selected product.

The select claims section 506 includes claim check boxes 520, one per claim in the currently selected patent. Here the analyst 116 selects which claims in the currently selected patent will be covered by the claim chart 124 being produced.

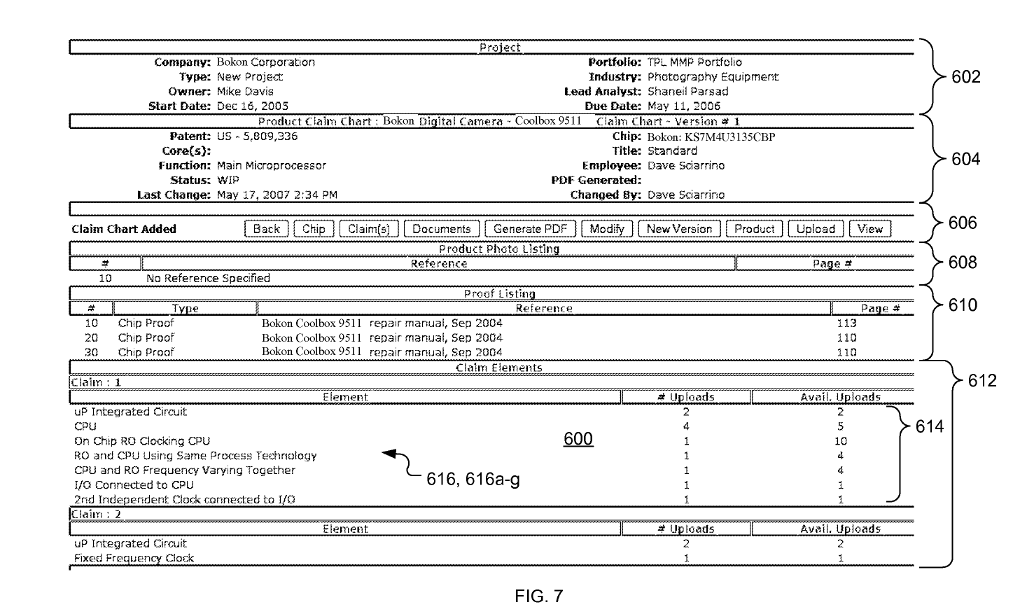

FIG. 7 is a view of a portion of a fourth WIP claim chart screen 600 that the analyst 116 will encounter (after operating the navigation control 202 in FIG. 6 that is labeled “Finish”). Included here are a project section 602, a product section 604, a controls section 606, a product photo listing section 608, a proof listing section 610, and a claims section 612. Further, within the claims section 612 are claim subsections 614 for each claim that was selected in screen 500.

The project section 602 here again presents the general project summary information, and the product section 604 here presents product summary information based on what was input in the new claim chart section 504 in screen 500.

The controls section 606 follows, and it is intentionally placed here, after the summary information that should be relatively fixed and before claim-specific and other information that may still be modified and which may be quite extensive and require scrolling down-screen to be seen.

The product photo listing section 608 presents information about any product photograph type references that have been associated with the currently selected product. As can be appreciated here, in this embodiment such references have a reference number, a reference title, and, if present, a page number that tentatively indicates where they will appear in the ultimate product report 122. FIG. 7 shows here that no product photograph references have been associated with the current product, so the next available reference number is shown along with a statement to this effect in place of a reference title.

Digressing briefly, the inventors use the term “upload” for many information units used in the analysis system 100. Generally, an upload is used as or in a proof piece for a claim element. Uploads can be photographs, drawings, citations from datasheets or user manuals, web pages, etc. Uploads can also especially be generic notes, which are created to explain various technical aspects of the claim element and which are common to every product with regard to a particular claim element. Thus, a reference such as a product photograph or a proof listing is an upload and uploading is the act of entering it into the analysis system 100. Of course, more than one proof piece can be uploaded and used in an element proof as support for a specific claim element (and these proof pieces can be sorted or arranged in any order desired to make the entire proof piece most easily understood).

It should also be appreciated, however, that the inventors also use the term “upload” to indicate that an information unit that has already been uploaded into the analysis system 100 is further associated with a part of a particular product report 122 or claim element in a claim chart 124. Thus, such a part or element may be referred to as having both “available” uploads, and simply “uploads,” wherein the latter indicates a sub-quantity of the presently available quantity of uploads that has formally been associated with the particular part or element. While this may seem confusing as it is stated here, in the context of actual practice it is straightforward and intuitive (see e.g., the exemplary claim subsections 614 in FIG. 7).

Continuing, the proof listing section 610 presents information about proof listing type references that have been associated with the currently selected product. The proof listings have a reference number, a reference type, a reference title, and a page number that tentatively indicates where they will appear in the ultimate product report 122. FIG. 7 shows that three proof listing references have been associated with the current product.

The claims section 612 is a shell for the claim subsections 614. For each claim that was selected in screen 500, a claim subsection 614 is presented in screen 600. Each of the claim subsections 614 includes columns for element labels, the number of uploads currently associated with a respective element, and the number of uploads currently available to be associated with a respective element. For example, the uppermost claim subsection 614 in FIG. 7 is for claim 1 and it lists seven claim elements (claim elements 616 collectively and claim elements 616a-g individually). The claim elements 616 here each already have uploads associated with them. For instance, the claim element 616b (second to topmost, labeled “CPU”) has four uploads currently associated with it out of five currently available in the analysis system 100 that potentially could be associate with this “CPU” claim element 616b. As will be seen next, in addition to providing information here, the claim elements 616 are control links to other functionality as well.

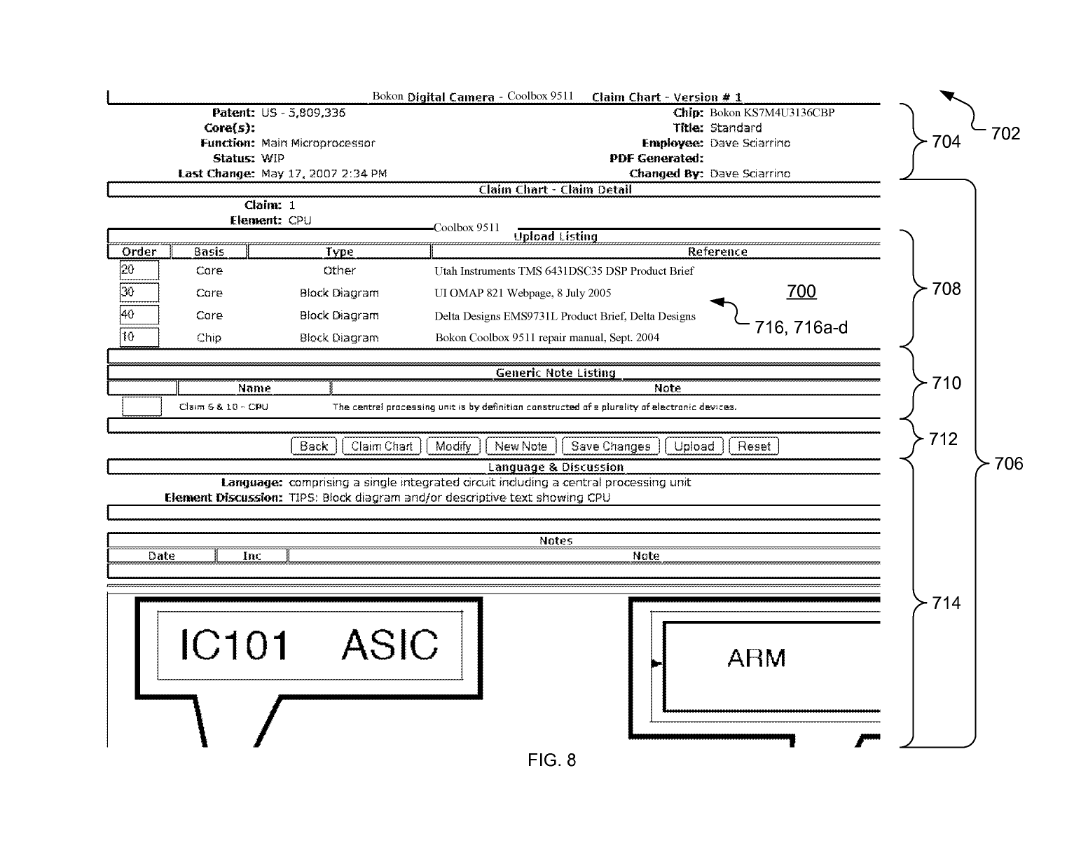

FIG. 8 is a view of a portion of a fifth WIP claim chart screen 700 that the analyst 116 will encounter (after operating claim element 616b in FIG. 7 as a control link to drill down). Included here are a project section 702 (off screen, above), a product section 704, and a claim detail section 706. The claim detail section 706 includes an upload listing subsection 708, a generic notes subsection 710, a controls subsection 712, and a discussion subsection 714.

The project section 702 includes the same information as the project sections 502, 602 and the product section 704 includes the same information as the product section 604. The claim detail section 706 states the claim number and what element of that claim is currently selected, and the subsections below provide more detail about this.

The upload listing subsection 708 lists the uploads that are already associated with the current claim element (i.e., claim element 616b here). Four uploads (uploads 716 collectively and uploads 716a-d individually) are shown here, with upload 716d selected. Note, the uploads 716 can be put into a custom ordering, which can be changed as desired. In addition to providing information here, the uploads 716 are also control links.

The generic notes subsection 710 lists any entries (text notes, uploads, etc.) that are associated with the current claim and claim element because they have generic relevance. For example, here there is a text note remarking on a point that relates to two claims that are dependant from the current claim. The analyst 116 can here add further notes or comments to the claim element to help clarify what is desired to complete the assertion of logic that the claim element is present in the infringing product. The inventors term completing such an assertion to “fulfill” a claim element (i.e., completing an element proof).

The controls subsection 712 follows, and it is intentionally placed here, generally after the information that should be relatively fixed and before information that typically is still to be modified or added to.

The content of the discussion subsection 714 is dictated by which upload 716a-d is selected (if any) in the upload listing subsection 708. Typically, as shown here, the discussion subsection 714 will state the literal language of the current claim element and the current discussion of that element. [While this is “summarizing” in nature and might be placed above the controls subsection 712, the importance of these is paramount to the task at hand and they are therefore placed where the analysts 116 are always reminded of this and are able to tailor their work here accordingly.] Finally, the discussion subsection 714 shows the content of the particular selected upload 716 (here that is upload 716d, which is a diagram taken from the manufactures repair manual for the current product).

Once all of the claim elements have been fulfilled with uploaded proof pieces, and those proof pieces have been ordered as desired, notes added, etc., the analyst 116 has completed work under the WIP tab 304a (FIG. 4).

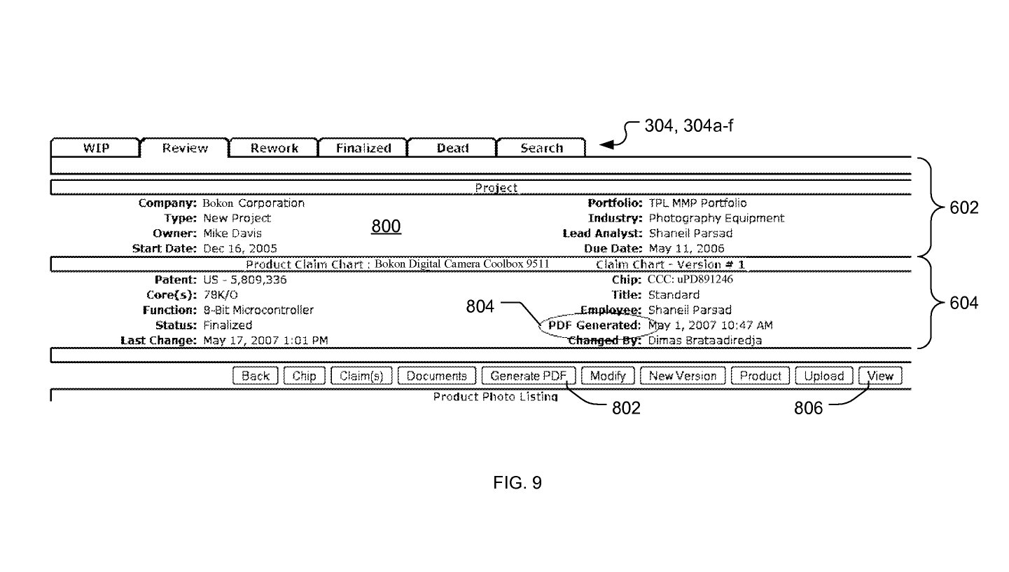

FIG. 9 is a view of a portion of a first review claim chart screen 800 that the analyst 116 will encounter after selecting the review tab 304b. In the inventors' presently preferred embodiment of the inventive analysis system 100, there are three ways to view claim charts 124: as a generated .pdf document, as an HTML view, and as individual claim element (i.e., as depicted in FIG. 6-7 and already discussed above).

Viewing a claim chart 124 (or an entire product report 122) as a .pdf document provides the analyst 116 with an ability to see exactly what the document will look like in final, printed form. To access this functionality the analyst 116 operates a control button 802 labeled “Generate PDF” and a PDF is automatically generated. After the first time this is done, a PDF link 804 will appear in the product section 604, and the analyst 116 now can simply click on this to have the PDF document version of the claim chart 124 pop up for viewing on the screen.

Viewing a claim chart 124 as an HTML display is done by the analyst 116 operating a control button 804 labeled “View.” This view generates an image similar to the PDF, but the formats are not exact. The advantage of this approach, however, is that it requires less data manipulation and transfer, and thus is less burdensome on the hardware being used, especially if one or more limited speed communication channels are involved or if at a remote location where encryption software is required. This view thus can open quickly and be more advantageous when working with the analysis system 100 remotely.

As has been noted, the analysis system 100 has been designed to leverage as much information as much as possible. When working with major patent portfolios 114 (e.g., the MMP and the COREFlash portfolios), it became evident to the inventors that many of the claim elements from one particular patent were, if not exact replicas from another patent, then nearly equivalent. For example, this can be seen in the patent language below for the following elements:
1) “comprising a main central processing unit (70)”
2) “A microprocessor comprising a main central processing unit”
3) “comprising a single integrated circuit including a central processing unit”
4) “providing said central processing unit upon an integrated circuit substrate, said processing unit operating at a processing frequency and being constructed of a first plurality of transistors and being operative at a processing frequency;
5) “A central processing unit disposed upon an integrated circuit substrate, said central processing unit operating at a processing frequency and being constructed of a first plurality of electronic devices”

These five elements come from three different patents in the MMP patent portfolio 114 of the inventors' employer (Alliacense, a TPL Group Enterprise). Further, three of these elements come from different claims from U.S. Pat. No. 5,809,336, while the other two come from EP '730 and JP '085 (equivalent s to the US '336 patent that have been issued by the European Patent Office and the Japanese Patent Office). Normally, when constructing claim charts, each of these elements would be considered separately, and different proof pieces would be required to prove this element. What the inventors have done in the analysis system 100 is to group all of these “different” elements into one element group named “CPU,” because in essence, even though different words were used for each of these elements, the basic proof piece required is a description of a microprocessor with a CPU. Thus, an analyst 116 can upload a single proof piece of a microprocessor with a CPU and it will satisfy five different elements for three different patents automatically. This vastly reduces the time necessary when creating multiple claim charts for different patents or claims. It also helps standardize the proof pieces, making technical arguments against the claims being infringed difficult to sustain, and it facilitates standardizing and re-using counter arguments.

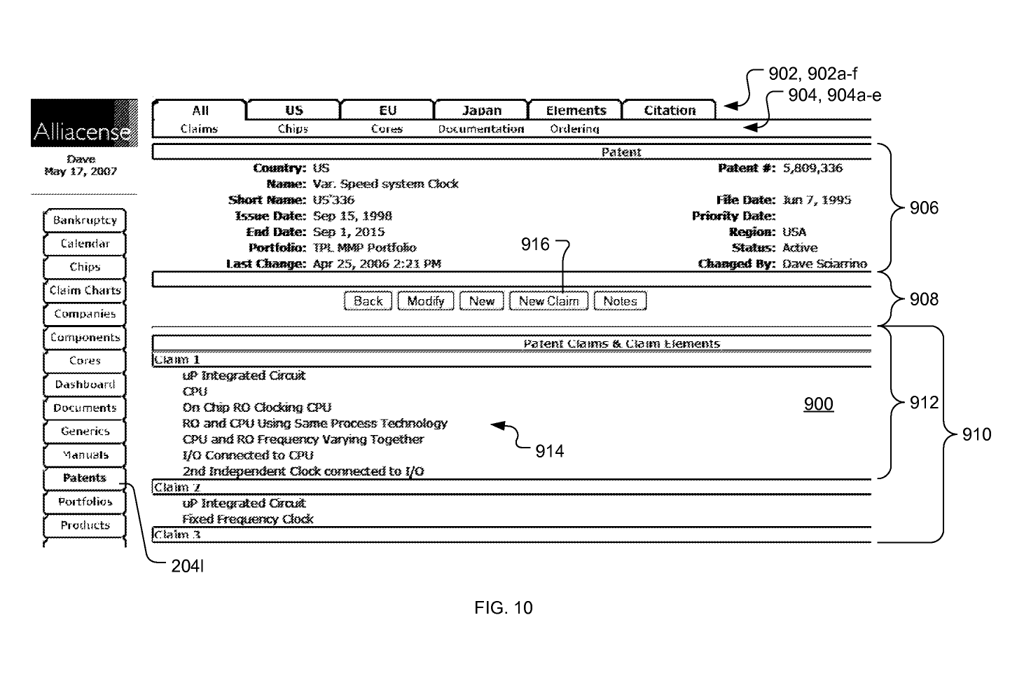

FIG. 10-13 are views of some of the other particularly useful screens in the inventors' presently preferred embodiment of the inventive analysis system 100.

FIG. 10 is a view of a portion of a first patents screen 900 that the analyst 116 will encounter after operating the button 2041 to access its corresponding patents module. The US '336 patent has already been selected. If the analyst 116 is using the analysis system 100 in a manner related to a specific patent, operating the button 2041 can automatically cause information for that patent to appear. Alternately, if it is not obvious which patent is of interest, a summary page (not shown) lists all patents in the analysis system 100. To get to a particular patent, one merely clicks on it.

Here tabs (tabs 902 collectively and tabs 902a-f individually) control what information about a patent is displayed. The all tab 902a is selected, and under it are sub-tabs (sub-tabs 904 collectively and sub-tabs 904a-e individually). The claims sub-tab 904a is selected here, which results in the screen 900 further showing a patent section 906 presenting patent summary information, a controls section 908, and a claims section 910. The claims section 910 includes one or more claim sub-sections 912, which each, in turn include one or more element links (element links 914 collectively and, for claim 1 depicted here, element links 914a-g individually). The individual element links 914 can be operated by the analyst 116 (e.g., by mouse click) to “drill down” to specific information about that element.

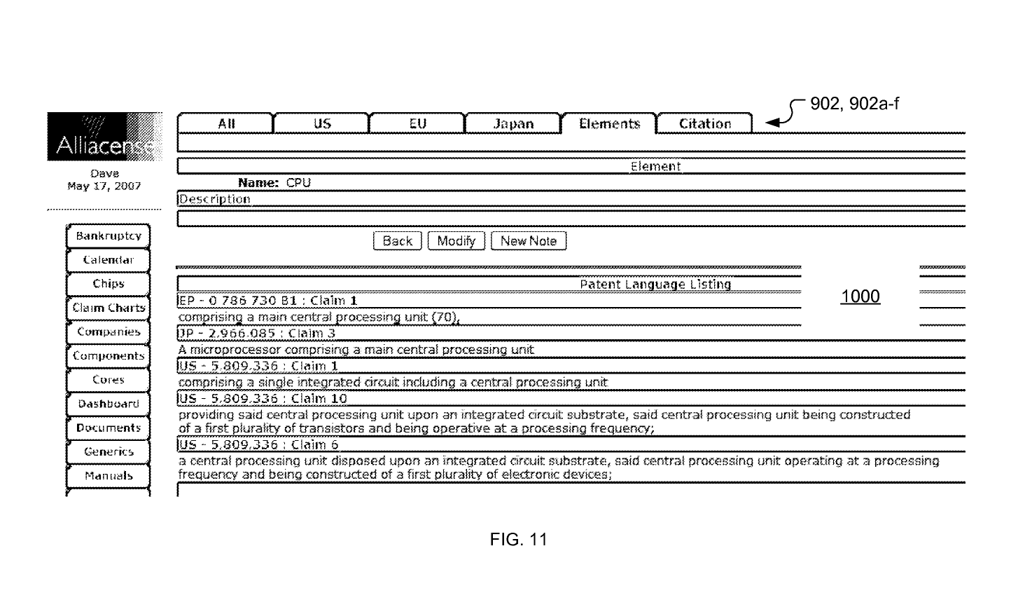

FIG. 11 is a view of a portion of a second patents screen 1000 that the analyst 116 will encounter after operating the element link 914b in FIG. 10. [N.b., selecting the elements tab 902e to access this functionality could alternately be used, but then a dialog (not shown) can further appear to permit the analyst 116 to specify the particular element of interest.]

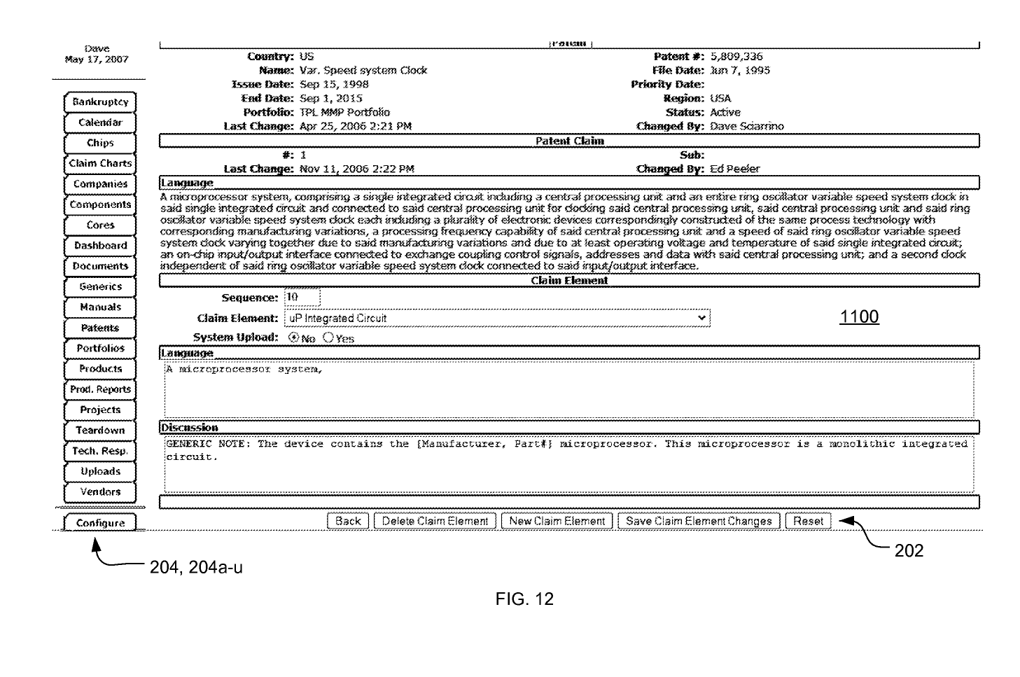

Digressing somewhat, FIG. 12 is a view of a portion of a third patents screen 1100 that the analyst 116 will encounter after operating a new claim button 916 in screen 900. The label “new claim” is somewhat of a misnomer here, since new claims are not added to an existing patent. Adding a new patent portfolio 114 or adding a new patent to an existing patent portfolio 114 effectively adds all of the patent claims and their text to the analysis system 100. The screen 1100 here is where the analyst 116 can then break such a “new” claim down into claim elements, add categorization, and add initial notes.

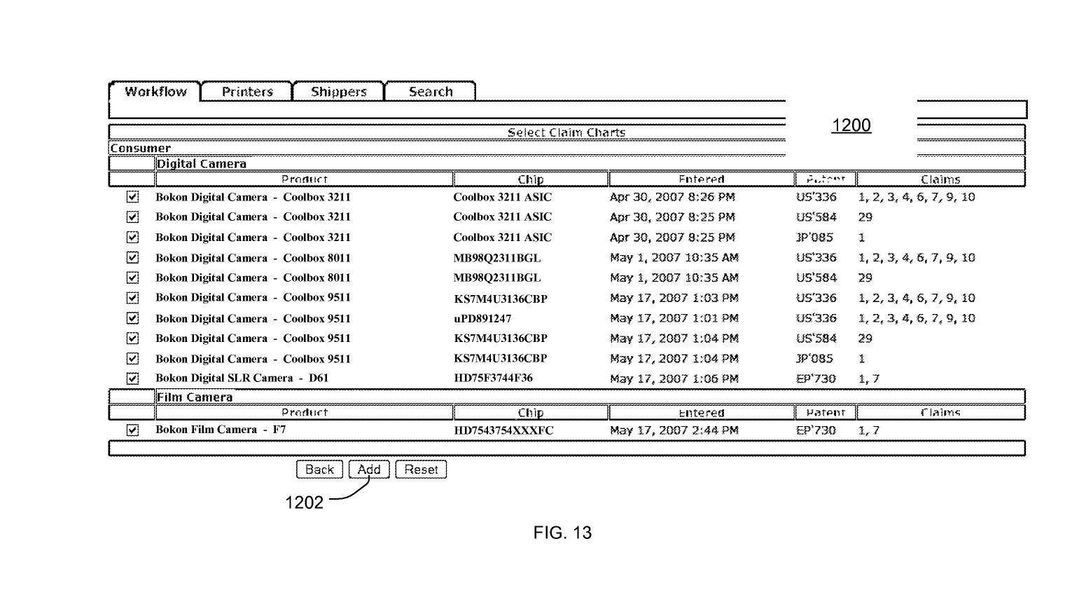

FIG. 13 is a view of a portion of a product report screen 1200 that the analyst 116 will encounter after operating the button 204o to access its corresponding product report module. Using the inventive analysis system 100, a product report 122 can be produced in a matter of minutes once an appropriate collection of claim charts 124 has been created. The analyst 116 now simply chooses the project in the analysis system 100 (already done in screen 1200 for the prospective licensee 118), and all of the claim charts 124 come into the view, sorted by product line in the various product portfolios 120 of the prospective licensee 118, and by whether the products are consumer or commercial products. Some or all of the claim charts 124 can now be chosen.

Once the claim charts 124 have been chosen for the product report 122, the analyst 116 merely has to click an add button 1202 and a PDF of the Table of Contents for the product report 122 is created automatically. The Table of Contents automatically has links created so that the individual documents (claim charts 124, reference documents, etc) in the product report 122 can be accessed with the click of the mouse.

An additional screen (not shown) allows the analyst 116 to generate or “Stage” the product report 122 itself. In the inventors' presently preferred embodiment of the analysis system 100 this loads all of the documents, including claim charts and reference documents into three separate file folders (Consumer, Commercial, and Reference) and loads them to a staging area on a server. This allows the analyst 116 producing the product report 122 to burn a copy of it to a CD or DVD and save it to another location on the server.

In the inventors' experience, use of the inventive analysis system 100 has saved several hours in the creation process of a product report 122 over the prior manual approach. Further, use of the analysis system 100 has resulted in a significant improvement in the quality of claim charts 124 and product reports 122 due to standardization and the reusability of standardized work product. Furthermore, the use of the product reports 122 and the entire process of infringement determination and licensing to alleviate this can now be tracked, managed, and logged better by using the inventive analysis system 100.

The following are summarizing remarks about an embodiment of the inventive analysis system 100 that the inventors' employer is using regularly. It should be noted that many of the features discussed here are technology-specific, since reducing the invention to an actual operating embodiment inherently entails choices of one technology over others. Some of the features discussed here are also industry-specific, since the present inventors developed this invention to initially serve a licensor 112 (their employer) which manages patent portfolios 114 in specific industries. These aspects of this exemplary embodiment of the inventive analysis system 100 should not be mistaken as limitations of the present invention. Other technologies could easily be used to create alternate embodiments of the analysis system 100 and other industries can also be well served by suitable alternate embodiments of the analysis system 100.

The analysis system 100 has been embodied as a web based application built in JAVA (™) on a MySQL (™) database platform and that operates using a Linux-based operating system (OS). Encryption is used to protect important data and SSL and other encryption mechanisms are used to ensure secure communication with remote locations. Active access and use via any computer using an Internet connection and a capable OS, are provided, once such a computer has been granted access. An on-line help/support system is also provided, to report bugs and service requests.

The analysis system 100 has been embodied to permit storing extensive information about patent portfolios 114, storing, managing, and filtering multiple patent portfolios 114 by country or region, as desired. Each patent portfolio 114 can include one or more patents, for which all relevant data can be stored, including important dates, file wrappers, etc. in the form of .pdf or other type documents. The patents can then be easily searched in the analysis system 100. Each patent has one or more claims associated with it, and all claim data is stored as well. Each patent claim is broken down into multiple claim elements. These elements are user defined and can be named and/or numbered as desired. The claim elements from different patent claims can share defined elements and be grouped as such. Thus, information can be leveraged by many different claims within a patent or by multiple patents, reducing repetitive inputs. The claim element language is split out separately within a view in the analysis system 100, and discussion notes can be added, as well as supporting documentation, prior art citations, etc.

The analysis system 100 has been embodied to facilitate various workflows that are consistent with its purpose and role.

A project workflow has descriptively labeled stages that include: Prospect, 1^{st} Response, PR Requested, WIP, Refresh, PR Complete, and On Hold. Briefly, “Prospect” is where a prospective licensee 118 is identified; “1^{st} Response” is where the prospective licensee 118 is qualified further; “PR Requested” is where a product report 122 is requested; “WIP” is where the product report 122 is a work-in-progress; “Refresh” is where the product report 122 is refined, amended, or added to as needed, “PR Complete” is where the product report 122 is considered completed; and “On Hold” is self explanatory.

A project workflow is a superset of one or more claim chart workflows and one or more teardown workflows. Other modules for these can be accessed directly from the Projects Module, reducing the number of mouse clicks needed for access. Separate projects can be created for prospective licensees 118, by subsidiaries or company segments, product lines, geographic location, etc.

A claim chart workflow has been discussed extensively already, wherein the stages are descriptively labeled and include: Work-in-progress (WIP), Rework, Review, Finalized, and Suspended.

A teardown workflow has descriptively labeled stages that include: Requested, Ordered, In Queue, WIP, Complete, In Inventory, and Disposal. A teardown is defined as the case when a product or component that has been acquired that is then disassembled, photographed, tested and (if possible) reassembled. The information gleaned from such a teardown can then be captured in the analysis system 100 and used by the analysts 116 to construct proof pieces and references for claim charts 124.

The following is a discussion of most of the modules in an embodiment of the inventive analysis system 100 that the inventors' employer is using regularly. A few modules are not discussed here, because they are not particularly relevant to the presently claimed invention.

BANKRUPTCY MODULE: This imports data from an external database on a weekly basis and compares the data with the prospective licensees 118 listed within the databases of the analysis system 100 to see if there are any matches. If there are matches, the information can be displayed so that these prospective licensees 118 can be reclassified (or placed on hold). This module also allows the user here to view the data listed by attorney, court, and judge as well as by corporate entity within the organization of the prospective licensee 118.

CALENDAR MODULE: Here users can input new or update current meetings related to licensing negotiations. The calendar has both monthly and weekly views. A user can drill into each meeting listed within the calendar and go directly to the project or meeting information tab associated with that calendar event. This module can also generate .PDF documents for easy printing, saving, or e-mailing.

CHIP MODULE: This module saves and stores all basic information regarding microprocessors that have been input and stored in the databases of the analysis system 100. Each chip is listed by manufacturer, product name, chip family, and the microprocessor core associated with the chip. Claim information associated with a chip is then easily loaded, and any proofs pieces are delineated by claim element, and all the proofs pieces uploaded into the analysis system 100 are displayable so that the user can view each claim element that has been proven against a particular chip. All chip claim element proof pieces are listed in the a basic view (chip module sub-tab) and each upload listing (claim element proof piece) can be viewed simply by clicking on the reference. All products using a particular chip can also be viewed merely by choosing the products sub-tab within the Chips Module. Chips can be listed in multiple products or components, so that all of the claim chart data listed for the chip can be used and leveraged for multiple products. Core data already loaded into the databases of the analysis system 100 can be added to the chip entries, so that any claim element proofs based on the core information is immediately available when creating claim charts. This reduces work and redundancy and creates uniformity when creating claim charts 124.

CLAIM CHARTS MODULE: The Claim Charts Module has its own set of workflow tabs, as stated earlier. Each tab shows all the claim charts 124 listed within that piece of the workflow. There are sub-tabs listed for each workflow tab. These include WIP, Review, Rework, Finalized, and Dead. “WIP” is used to segregate out all of the claim charts 124 currently in a work-in-progress state by analyst 116 or by all claim charts 124 in the analysis system 100. Different colors are used to signify whether a claim chart 124 is for a component or a product. “Review” is used to indicate claim charts 124 that need to be reviewed for quality assurance purposes, to make sure they are accurate. “Rework” is used to indicate that a claim chart 124 is not up to spec, the reviewer makes comments and sends the claim chart 124 back to the analyst 116 for revision. When revisions are made, the analyst 116 returns the claim chart to Review. “Finalized” indicates that a claim chart 124 is approved by a manager, i.e., that it has been moved here from Review. “Dead” is used to indicate that it has been determined that a claim chart 124 does not satisfy all of the claim elements.

A new claim chart 124 is associated with a prospective licensee 118, a product in a product portfolio 120 for a prospective licensee 118, and a patent in a patent portfolio 114. Multiple claims can be chosen (or not) for a particular claim chart 124. Photos and other documents can be loaded into the analysis system 100. Proof that the product contains infringing modules or chips are loaded, as well as proof pieces that satisfy each of the claim elements associated with a particular claim of a patent. The component (or chip or core) cited can be used for other claim charts 124. Thus, the information gained for infringement purposes can be shared and leveraged for many claim charts and target companies. The analysts 116 have the ability to add notes directly associated with the claim element proof piece or associated with the product itself. Those notes or proof pieces associated with a claim element can automatically be pulled into a claim chart 124 without user intervention. Those proof pieces associated with a product and claim element combination are only associated with that particular claim chart 124.

Information for claim charts 124 is input in the form of uploads of image files and notes added by analysts 116. Once all of the information is loaded to complete all of the elements associated with a claim chart 124, a .pdf document is generated that puts all of the information in a format that is uniform and printable. Individual claim element proofs can be viewed in the analysis system 100 simply by clicking on the element that is listed. Changes to any notes can also be made directly from this spot.

COMPANIES MODULE: This contains all the basic information regarding a prospective licensee 118, including product and financial data. The prospective licensees 118 can be easily searched with a quick search option. The prospective licensees 118 are indexed by company segment, subsidiary and product line. Data can easily be input into the database tables 134 of the analysis system 100 here, and products can be linked to each of these areas and rolled up within a hierarchy. The prospective licensees 118 are also segmented by industry groups, as well as types (manufacturer, retailer, etc.). [N.b., the inventors frequently use the term “company” to refer to a prospective licensee 118. The term “prospective licensee” has been used herein, however, to emphasize the purpose and role of the analysis system 100.]

COMPONENTS MODULE: Here components are defined as individual units that make up a product. There can be multiple components within a product, and current embodiments of the analysis system 100 create a hierarchy of up to one-hundred components. Thus, one can list a component within a component all the way up. The same component can be used for different products, in the same way that a chip can be used in multiple products. The basic component data used includes the component name, the model number and the manufacturer. In current embodiments, each individual component is shown with four sub-tabs, for chips, claim charts, notes, and summary. The chips tab lists all chips that have been listed by the user for that component. The claim charts tab lists all claim charts 124 that have been created for a given component. The notes tab list any notes entered by analysts 116 regarding the component. The summary tab then provides a place for any more general remarks.

CORES MODULE: This refers to the computing engine, or microprocessor core of an integrated circuit chip. Cores can be shared by multiple chips, and different manufacturers can supply cores for different chips. Basic information can be loaded into the databases of the analysis system 100 in the form of notes or with uploads of other data. All of the chips associated with a given core are typically listed in the analysis system 100 under a sub-tab. [N.b., the employer of the present inventors primarily controls patent portfolios 114 that are related to electronics devices and especially to micro processors. This should not, however, be interpreted as limiting the scope of the inventive analysis system 100. Once the teachings herein are grasped, it should be appreciated that the analysis system 100 can readily be adapted and extended to quite different patent portfolios and industries. For instance, to the chemicals and the pharmaceuticals industry.]

DOCUMENTS MODULE: This is a listing of all documents that have been loaded into the analysis system 100. Documents can take many different forms including .pdf, .png, .doc, etc. Documents can be searched quickly by name or by document type.

GENERICS MODULE: Generic notes and proofs can be added to the analysis system 100. These “Generics” are added in the event that a particular claim element has a uniform proof that does not vary by product.

MANUALS MODULE: These are documents associated with particular products in product portfolios 120 or prospective licensees 118. In general, these are service manuals that have a great deal of information regarding a product and the parts that make it up.

PRODUCTS MODULE: The products are listed in their own module here by product name, model number and by manufacturer. Products can be linked to product lines as well. Product descriptions can be added at the module level. Sub-tabs associated with products include: chips, claim charts, financial, notes, product reports, summary, and uploads. The chips tab lists the chips that have been input into the databases of the analysis system 100 for this product. This tab link back to the Chips Module as well, for easy viewing. The claim charts tab permits all of the charts associated with a given product to also be viewed. The data here includes the patent, chip, claim current status of the claim chart and the date it was last changed. The user can click through on a view of a claim chart to see all of the claim chart data as well. The financial tab presents revenue data for a given product, if available. That information can also be added to the databases of the analysis system 100 and displayed. The notes tab permits any notes regarding a product to be added, stored, and displayed. The product reports tab provides a listing of all the product reports 122 that a product is listed in. The summary tab shows a detailed summary of the claims for each of the patents in the patent portfolio 114, the number of elements within a claim, and the number of elements currently satisfied by claim proof pieces. The uploads tab shows each of the uploads associated with a particular product. The users can click through to the reference documents cited. [N.b., the inventors frequently use the term “products” to refer to a product portfolio 120. Herein the term “product portfolio” is used when more than one product related by source is being discussed. This also helps to emphasize the purpose and role of the analysis system 100.]

PRODUCT REPORTS MODULE: These are a compilation of claim charts 124 for a given prospective licensee 118. They have their own workflow associated with them, including WIP, Printed, Shipped, and Received. A product report 122 is automatically assembled and produced by the analysis system 100 in the manner described already herein. A product report 122 includes “Tables of Contents” that links directly to each claim chart 124 merely mouse click. In present embodiments of the analysis system 100, .pdf documents are generated for each claim chart 124 and also for each reference cited in each claim chart 124.

TECHNICAL RESPONSE MODULE: This is used in regard to the idea that a prospective licensee 118, upon meeting with the licensor 112, will typically have questions regarding the technical veracity of the claim charts 124 in a product report 122. It has been the inventor's observation that many of the technical questions received from the different prospective licensees 118 are often very similar. Thus, the analysis system 100 here categorizes each of the questions by project, patent, product, and claim element. A question and its response are thus stored in the analysis system 100 and can be easily retrieved and utilized for different responses in the future. For example, the responses to prospective licensees 118 can be used and edited or altered for other prospective licensees 118 as well; the responses can be easily searched; and each response can also go through the basic workflow of WIP, Review, Rework, and Finalized.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A process for creating a claim chart, the process comprising:
(a) maintaining information about a patent portfolio in a database, wherein said patent portfolio includes at least one patent which includes at least one claim which has at least one claim element;
(b) maintaining information about a product portfolio in said database, wherein said product portfolio includes at least one product which has at least one product characteristic;
(c) maintaining a collection of proof pieces in said database that each represent an assertion about a said product characteristic;
(d) selecting a current product that is a said product in said product portfolio;
(e) selecting a current patent that is a said patent in said patent portfolio;
(f) selecting a current claim that is a said claim in said current patent;
(g) for each said claim element of said current claim, constructing an element proof by selecting a said proof piece showing that a product characteristic of said current product matches said claim element; and
(h) generating a document showing the claim chart as a collection of said element proofs.

2. The process of claim 1, wherein:
said information about said patent portfolio includes relationships between said patents, wherein said relationships include at least one member of the set consisting of relationship by patent family, relationship by geographic patent jurisdiction, relationship by similarity in said claim elements, relationship by hierarchical citation of one said patent in another said patent, and relationship by common citation of multiple said patents in a same publication.

3. The process of claim 1, wherein:
said (a) includes storing information about components in relation with said patents, wherein said components have previously been determined to have a said product characteristic for a said product other than said current product.

4. The process of claim 3, wherein:
said information about said components includes hierarchical relationships wherein some said components include other said components.

5. The process of claim 3, wherein:
said (e) includes selecting at least one said component.

6. The process of claim 1, wherein:
said information about said product portfolio includes relationships between said products, wherein said relationships include at least one member of the set consisting of relationship by a said product characteristic, relationship by product feature, relationship by product line, relationship by manufacturing method, relationship by manufacturing materials, relationship by manufacturing location, relationship by same manufacturing entity of another said product, and relationship by legal connection to a said manufacturing entity of another said product.

7. The process of claim 1, wherein:
at least some said proof pieces are members of the set consisting of notes, drawings, diagrams, and photographs.

8. The process of claim 1, wherein:
a said proof piece includes a reference to a source of at least a part of said proof piece.

9. The process of claim 1, wherein:
at least a part of said proof piece is from a source that is responsible for a member of the set consisting of manufacturing, selling, and servicing a said product.

10. The process of claim 9, wherein:
said source is responsible for a member of the set consisting of manufacturing, selling, and servicing said current product.

11. The process of claim 1, further comprising:
maintaining information about a prospective licensee that controls said patent portfolio in said database.

12. A computer program, embodied on a computer readable storage medium, for creating a claim chart, the computer program comprising:
(a) a code segment that maintains information about a patent portfolio in a database, wherein said patent portfolio includes at least one patent which includes at least one claim which has at least one claim element;
(b) a code segment that maintains information about a product portfolio in said database, wherein said product portfolio includes at least one product which has at least one product characteristic;
(c) a code segment that maintains a collection of proof pieces in said database that each represent an assertion about a said product characteristic;
(d) a code segment that permits selection of a current product that is a said product in said product portfolio;
(e) a code segment that permits selection of a current patent that is a said patent in said patent portfolio;
(f) a code segment that permits selection of a current claim that is a said claim in said current patent;
(g) a code segment that constructs an element proof for each said claim element of said current claim by selection of a said proof piece showing that a product characteristic of said current product matches said claim element; and
(h) a code segment that generates a document showing the claim chart as a collection of said element proofs.

13. The computer program of claim 12, wherein:
said (a) includes a code segment that maintains relationships in said information between said patents when said relationships include at least one member of the set consisting of relationship by patent family, relationship by geographic patent jurisdiction, relationship by similarity in said claim elements, relationship by hierarchical citation of one said patent in another said patent, and relationship by common citation of multiple said patents in a same publication.

14. The computer program of claim 12, wherein:
said (a) includes a code segment that stores information about components in relation with said patents when said components have previously been determined to have a said product characteristic for a said product other than said current product.

15. The computer program of claim 14, wherein:
said information about said components includes hierarchical relationships wherein some said components include other said components.

16. The computer program of claim 14, wherein:
said (e) includes a code segment that permits selection of at least one said component.

17. The computer program of claim 12, wherein:
said (b) includes a code segment that maintains relationships in said information between said products, wherein said relationships include at least one member of the set consisting of relationship by a said product characteristic, relationship by product feature, relationship by product line, relationship by manufacturing method, relationship by manufacturing materials, relationship by manufacturing location, relationship by same manufacturing entity of another said product, and relationship by legal connection to a said manufacturing entity of another said product.

18. The computer program of claim 12, wherein:
at least some said proof pieces are members of the set consisting of notes, drawings, diagrams, and photographs.

19. The computer program of claim 12, further comprising:
a code segment that maintains information about a prospective licensee that controls said patent portfolio in said database.

20. A system for creating a claim chart, comprising:
means for maintaining information about a patent portfolio in a database, wherein said patent portfolio includes at least one patent which includes at least one claim which has at least one claim element;
means for maintaining information about a product portfolio in said database, wherein said product portfolio includes at least one product which has at least one product characteristic;
means for maintaining a collection of proof pieces in said database that each represent an assertion about a said product characteristic;
means for selecting a current product that is a said product in said product portfolio;
means for selecting a current patent that is a said patent in said patent portfolio;
means for selecting a current claim that is a said claim in said current patent;
means for constructing an element proof for each said claim element of said current claim by selecting a said proof piece showing that a product characteristic of said current product matches said claim element; and
means for generating a document showing the claim chart as a collection of said element proofs.
